(19) United States
(12) Patent Application Publication
(10) Pub. No.: US 2005/0098208 A1
(43) Pub. Date: May 12, 2005

(54) Branch connection method

(76) Inventor: Henry E. Topf JR., Wellsboro, PA (US)

Correspondence Address: David L. Schwartz, Esq.;Wallenstein Wagner & Rockey, Ltd., 53rd Floor, 311 South Wacker Drive, Chicago, IL, 60606-6630, US

(21) Appl. No.: 10/704,864

(22) Filed: Nov. 10, 2003

(51) Int. Cl. F16K 43/00

(52) U.S. Cl. 137/15.14

(57) ABSTRACT

A method and apparatus are provided for connecting a branch onto a pipeline assembly having a radial circumference and an axial length without stoppage of passage of flow of a fluid through the pipeline assembly. The method includes mounting a sleeve around a portion of the radial circumference of the pipeline assembly. The sleeve comprises a first sleeve portion and a second sleeve portion, and the first sleeve portion comprises a cutting tool and the second sleeve portion comprises a branch for connection onto the pipeline assembly. The method includes securing the sleeve to the pipeline assembly. The pipeline assembly is milled to create an aperture of a length and width at the desired location by use of the milling machine; and the sleeve is rotated radially so that the second sleeve portion is aligned with the aperture. The branch is connected onto the pipeline assembly while the second sleeve portion is aligned with the aperture.

### TECHNICAL FIELD

The present invention relates to the connection of branches onto a pipeline assembly. More specifically, it relates to the connection of branches onto a pipeline assembly without stopping the fluid flow in the pipeline assembly during connection.

### BACKGROUND OF THE INVENTION

It is routinely desired to connect a branch usually including a valve onto an existing pipeline assembly. While it may be simplest to do by completely shutting off the fluid flow in the pipeline assembly during connection, this is often not practical or possible. It is known to insert a valve across the diameter of a pipeline without stopping the fluid flow, but the previous methods have numerous disadvantages. For example, U.S. Pat. No. 6,357,471 discloses a method of inserting a valve utilizing a gate and cutting tool spaced apart in the axial direction. After the cutting tool cuts and grooves the pipe, a worker removes the cutting tool from the valve casing and then closes an operation valve. The worker transfers the valve casing in the axial direction of the already-installed pipe, transferring the gate to a position that corresponds to that of the cut groove. This method for valve insertion requires movement of the entire assembly in the axial direction after cutting and before insertion of the valve. This method does not disclose connecting a branch onto a pipeline assembly.

A need exists for an improved method of and apparatus for hot tapping a pipeline for connecting a branch.

A need exists for an improved method of and apparatus for hot tapping a pipeline for connecting a branch for flow control.

A need exists for an improved method of removal of milling chips that may be formed during the milling process.

The present invention is provided to solve the problems discussed above and other problems, and to provide advantages and aspects not previously provided.

### SUMMARY OF THE INVENTION

According to one aspect of the present invention, an apparatus for connecting a branch onto a pipeline assembly without stoppage of passage of flow of fluid through the pipeline is provided. The apparatus comprises a sleeve. The sleeve comprises a first sleeve portion and a second sleeve portion. The first sleeve portion comprises an area capable of receiving a cutting tool and a valve, and the second sleeve portion comprises a branch to be connected onto the pipeline. The sleeve is rotatable relative to the pipeline assembly to permit milling of the pipeline assembly of variable lengths.

According to another aspect of the present invention a method for connecting a branch onto a pipeline without stoppage of passage of flow of a fluid through the pipeline assembly is provided. The method comprises the steps of mounting a sleeve around a portion of a radial circumference of the pipeline assembly. The sleeve includes a first sleeve portion and a second sleeve portion. The first sleeve portion comprises a cutting tool and the second sleeve portion comprises a branch for connection onto the pipeline assembly. The pipeline assembly is then milled to create an aperture at a desired location in the pipeline assembly. The aperture is milled to a length and width at the desired location by use of the cutting tool. The sleeve is then rotated radially so that the second sleeve portion is aligned with the aperture. The branch is connected to the pipeline assembly while the second sleeve portion is aligned with the aperture.

According to yet another aspect of the present invention, a method of removing milling residue from a sleeve and pipeline assembly is provided. The method comprises the steps of: isolating the area around a milling machine and pipeline assembly; providing a chamber to receive residue from the milling machine; milling material from the pipeline assembly to form a residue; and using a magnet to attract the residue into the chamber.

According to still another aspect of the present invention, a method of electrically isolating a section of a pipeline assembly without stopping fluid flow in the pipeline assembly is provided. According to this method, a sleeve is mounted around a portion of the radial circumference of the pipeline assembly. The sleeve comprises a milling machine and a portion adapted to attach to the section of the pipeline assembly. The pipeline assembly is then milled through 360 degrees in the radial direction at a desired axial location by use of the milling machine to form the electrically isolated section. Finally, the sleeve is attached to the electrically isolated section of the pipeline assembly.

According to yet another aspect of the present invention, a cutting tool for milling a slot in a pipeline assembly is provided. The tool comprises a substantially cylindrical body having a top end surface, bottom end surface and outer circumferential surface. The tool further comprises a plurality of first tips projecting out from the bottom end surface of the body and away from the body, a plurality of second tips projecting out from the top end surface of the body and away from the body, and a plurality of third tips projecting out from the circumferential surface. The first tips are configured to be used for penetration of the tool into the pipeline assembly, and the second tips are configured to be used for milling through the pipeline assembly. Finally, the third tips are configured to be used for retraction of the cutting tool from the pipeline.

According to another aspect of the present invention, a method for improving the sealing characteristics of a portion of a pipeline assembly is provided. First, a portion of the pipeline assembly is provided. Then, the portion of the pipeline assembly is cleaned. Finally, a bonding product is applied to the pipeline assembly that improves the sealing characteristics of the portion of the pipeline assembly.

In accordance with yet another aspect of the invention, an apparatus is provided that permits connection of branches on a relatively inexpensive basis. The learning curve with respect to using the method and apparatus is short. Also, since the flow through the pipeline assembly may continue during the connection procedure, it is more convenient to use.

These and other advantages and features will be made apparent from the following description of the drawings and detailed description of the invention.

### BRIEF DESCRIPTION OF THE DRAWINGS

FIG. 1 is a horizontal sectional view showing a sleeve mounted on a pipeline assembly and the cutting tool engaging the pipeline;

FIG. 2 is a horizontal sectional view showing a sleeve rotated along the pipeline assembly and the cutting tool engaging the pipeline;

FIG. 3 is a horizontal sectional view showing the condition of the embodiment with a branch connection attached;

FIG. 4 is a horizontal sectional view showing a sleeve mounted on a pipeline assembly;

FIG. 5 is a horizontal sectional view showing the condition of the embodiment with the sleeve isolated and the chamber installed;

FIG. 6 is a horizontal sectional view showing the condition of the embodiment with the magnet within the pipeline assembly;

FIG. 7 is a horizontal sectional view showing the condition of the embodiment with the sleeve rotated;

FIG. 8 is a horizontal sectional view showing the condition of the embodiment with the magnet and residue retracted from the pipeline assembly;

FIG. 9 is a horizontal sectional view showing isolating a section of the pipeline;

FIG. 10 is a perspective view showing an improved cutting tool of the present invention;

FIG. 11 is a horizontal sectional view showing the condition of the embodiment with the cutting tool engaged on the pipeline assembly;

FIG. 12 is a horizontal sectional view showing the condition of the embodiment with the sleeve rotated; and,

FIG. 13 is a horizontal sectional view showing the condition of the embodiment with the sleeve further rotated.

### DETAILED DESCRIPTION OF THE PREFERRED EMBODIMENT

While this invention is susceptible to embodiment in many different forms, there is shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

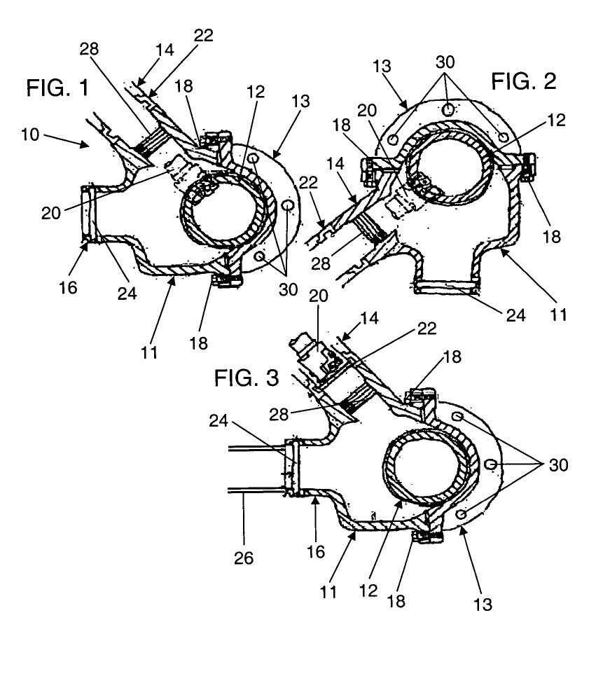

As shown in FIGS. 1-3, an apparatus and method for connecting a branch onto a pipeline assembly without stoppage of the passage of flow of a fluid through the pipeline assembly is provided. The term “pipeline assembly” as used herein means more than one pipe connected together in which a fluid, such as water or gas, flows, and is typically buried under ground. The pipeline assembly may be made of, for example, steel, iron, polyvinyl chloride, fiberglass or polyethylene. The pipeline assembly has a generally radial circumference and an axial length. The term “branch” as used herein means a top side branch pipe, bottom side branch pipe or any other member capable of having a service pipe connected thereto.

Sleeve 10 is mounted around at least a portion of the radial circumference of a pipeline assembly 12. Sleeve 10 is preferably a split sleeve. Sleeve 10 comprises a front sleeve plate 11 with an integral first sleeve portion 14 and a second sleeve portion 16. Typically, sleeve 10 also includes a back sleeve plate 13. Both front sleeve plate 11 and back sleeve plate 13 have openings to receive bolts 18, as well as openings for receipt of end pack bolts or gaskets 30.

The first sleeve portion 14 comprises an area capable of receiving a cutting tool 20 such as a milling machine or other milling-type tool having a plurality of cutting edges in each of the free end surfaces. Typically, first sleeve portion 14 also includes an area capable of receiving a valve 22 (illustrated in FIGS. 1 and 2 in the open position) which can be opened and closed. First sleeve portion 14 also includes threading 28.

Second sleeve portion 16 comprises a branch 26 for connection onto the pipeline assembly. Typically, second sleeve portion 16 includes a valve 24 which can be opened and closed. The first sleeve portion 14 and second sleeve portion 16 may be separated by approximately sixty degrees in the radial direction, or more preferably by ninety degrees in the radial direction, but it is understood that this can be varied depending on the pipeline assembly and desired goals.

First, a desired area to mill is located on a pipeline assembly. The area is thoroughly cleaned and then lubricated as is known to those skilled in the art. Sleeve 10 is then mounted on the pipeline assembly at the desired location. Front sleeve plate 11 is placed on the pipeline assembly and then the back sleeve plate 13 is placed on the pipeline assembly. Bolts 18 are then secured attaching front sleeve plate 11 to back sleeve plate 13. Next, end pack bolts 30 are tightened sufficiently to seal sleeve 10 to the pipeline assembly.

The pipeline assembly is then milled, without stoppage of flow of the fluid, using the cutting tool 20 to create an aperture or slot at a desired location in the pipeline assembly. The aperture is milled to a length and width at the desired location. The pipeline assembly may be milled at any place on its radial circumference or axial length. The sleeve may be repositioned radially to position the sleeve for additional milling to increase the length of the milled slot.

Additionally, the width of the slot may be increased by axially repositioning the sleeve. Because a large amount of force is required to move the mounted sleeve in the axial direction, a separate device may be used to facilitate this movement. The device is attached to the pipeline assembly at slightly beyond each side of the sleeve. The device can move the sleeve by any suitable means a short distance in either direction within the same band of the pipeline assembly. The device can be chain-driven, used like a winch or rack and pinion. The milling step is then repeated at the new axial location. The device may be used to move the sleeve multiple times to permit the width of the slot to be substantially increased. For example, for a eight inch main line pipe, the slot could be tapped to a eight inch by two inch branch, eight inch by four inch branch, eight inch by six inch branch, eight inch by eight inch branch, or any other size. If desired, the area of the milled slot may be approximately equal to the area of the cross-section of the pipeline assembly.

After the slot is milled to the desired dimensions, cutting tool 20 is retracted and isolated using valve gate 22 or another member for closing the flow passage. A thread completion plug (not shown) is threaded onto first sleeve portion 14 using threading 28, and preferably a cap is also placed to ensure that flow is blocked through the first sleeve portion 14. Cutting tool 20 and valve gate 22 have been removed from the sleeve and may be reused.

Thereafter, as shown in FIG. 3, sleeve 10 is rotated radially so that the second sleeve portion 16 is aligned with the slot milled by the cutting tool. Preferably, valve 24 is present and closed. Bolts 30 are tightened further to ensure the seal. Branch 26 is securely connected to second sleeve portion 16. Alternatively, branch 26 may be connected substantially later in time if desired. After connection of branch 26, valve 24 is then opened. Flow of the fluid may continue through the slot milled by the cutting tool. Branch 26 can be a side top tap branch, bottom side tap branch or other branches as are known in the art. The method can also be used repeatedly to connect more than one branch and, several different slots may be milled on a single pipe. For example, it is contemplated that two separate slots may be milled at a single desired axial location on a pipeline assembly, and a sleeve with a third sleeve portion can be utilized to connect a branch to the second slot. Also, by controlling the width of the slot milled and the length of the slot milled, the exact volume and flow desired can be accomplished to suit any pipe size by, to and including size for size connections.

A method of removing milling residue from a sleeve and pipeline assembly is also provided. Referring to FIGS. 4-8, this is accomplished without stopping fluid flow in the pipeline assembly. First, a milling machine (illustrated by cutter head 100) within a sleeve 102 or other isolation device is engaged on a pipeline assembly 104. Engagement of head 100 with the pipeline assembly 104 results in displacement of the material of the pipeline assembly and the formation of residue 108 or chips formed of this material. The milling machine 100 is retracted and isolated from the pipeline assembly 104. This isolation may be accomplished by, for example, a gate valve 110 or any other member for closing flow passage.

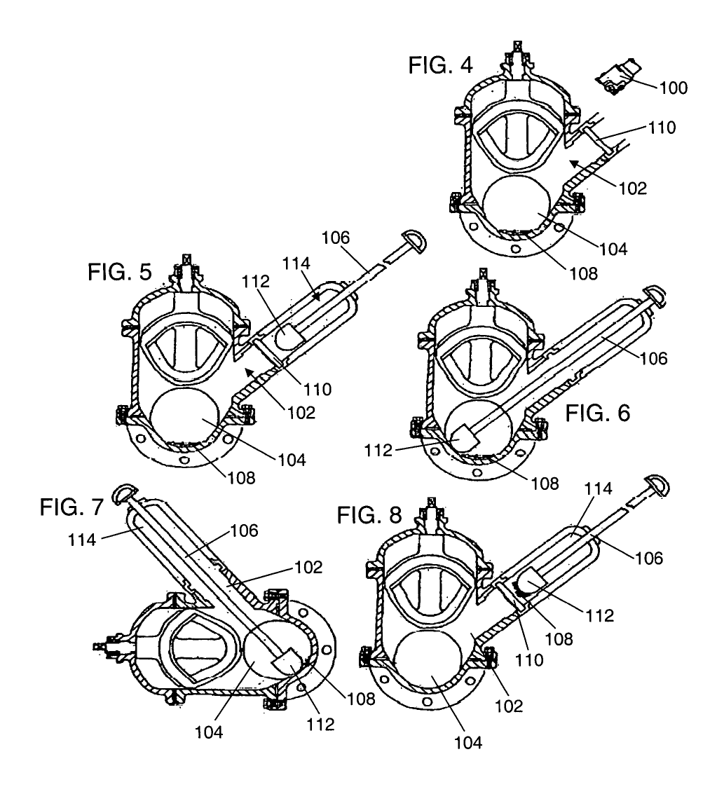

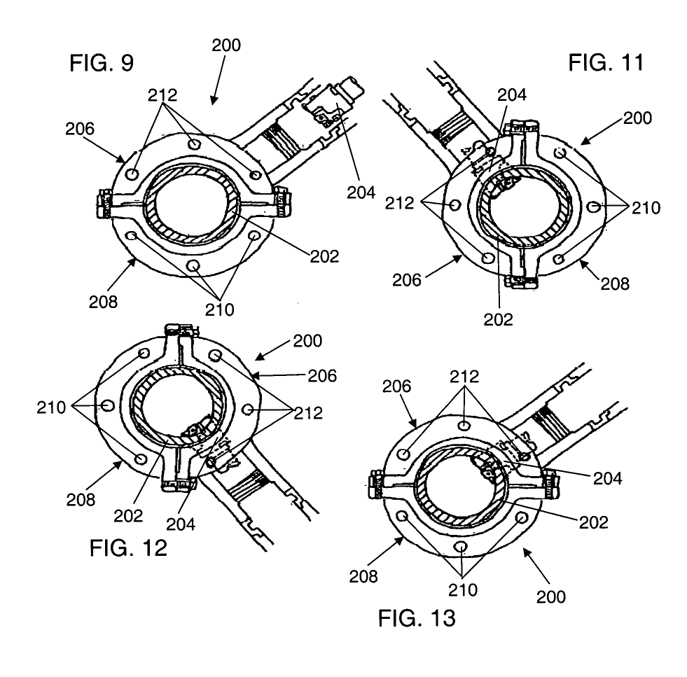

As illustrated in FIG. 5, a magnet 112 and residue chamber 114 are then readied for connection onto sleeve 102 and pipeline assembly 104. Chamber 114 is securely attached to sleeve 102. Preferably, chamber 114 is a pressure vessel. The isolation is then removed, for example, by opening gate valve 110. As shown in FIG. 6, magnet 112 is inserted through sleeve 102 and into pipeline assembly 104 by use of rod 106. Magnet 112 attracts residue 108. Sleeve 102 may be rotated, as illustrated in FIG. 7, to attract residue that are in difficult to reach locations.

Referring to FIG. 8, magnet 112 is then retracted from pipeline assembly 104 and into residue chamber 114, wherein the residue 108 is separated from magnet 112. Valve gate 110 is closed for isolation. The residue 108 is then within chamber 114. Magnet 112 may be reconnected onto pipeline assembly 104 numerous times to ensure a thorough removal of the residue from the pipeline assembly. Chamber 114 should be of sufficient volume to contain residue 108. However, chamber 114 may be emptied periodically to permit removal of additional residue. In one embodiment of the present invention, for ease of use, the magnet is located in the same sleeve portion as the cutting tool. In an alternative embodiment, the magnet and chamber may be located in a third sleeve portion which is separated by approximately sixty degrees in the radial direction between the first sleeve portion and the second sleeve portion.

Alternatively, instead of magnet 112, a steel magnetized brush may be utilized. The brush uses steel magnetized bristles. In a closed position, a sleeve maintains the bristles in close proximity to one another. In an opened position, the sleeve is withdrawn and the bristles spread apart. The brush is in the closed position during insertion and retraction into pipeline assembly 104 to minimize required-space. Once inside pipeline assembly 104, the sleeve is removed and the brush is placed in the open position to facilitate collection of residue 108.

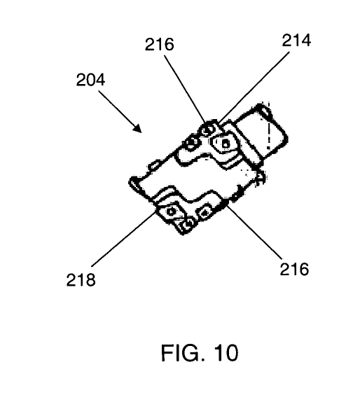

Turning now to FIGS. 9-13, there is provided a method of electrically isolating a section of a pipeline assembly. This is typically done for the purpose of cathodic protection. A sleeve 200 is electrically isolated from the pipeline 202. Sleeve 200 includes a front sleeve plate 206 and a back sleeve plate 208. Front sleeve plate containing openings capable of receiving end pack bolts 212 and back sleeve plate 208 contain opening capable of receiving end pack bolts 210. Sleeve 200 also includes a specialized cutting tool 204, illustrated in FIG. 10, which has cutting surfaces 214, 216 and 218 on top, side and bottom respectively.

As shown in FIGS. 11-13, sleeve 200 is rotated through 360 degrees in the radial direction around pipeline 202, and this allows cutting tool 204 to mill a slot in the pipeline 202 through the entire 360 degrees. Frequently, because the pipeline assembly is under pressure, the pipeline may move during the milling procedure. Occasionally, the pipeline may spring together and catch the cutting tool within the pipeline. In these circumstances, the specialized cutting tool 204 with top cutting surface 214 can be utilized to mill on retraction of the tool. Thus, cutting tool 204 can mill itself out of the pipeline. By doing so, the electrical continuity between the pipeline ends are eliminated by the slot. The milling chips are removed by the above described method or any other method known to those skilled in the art. Finally, the sleeve may electrically bonded to one end of the section of the pipeline. To electrically bond the sleeve to only one section of the pipeline assembly, end pack bolts are tightened on one plate of the sleeve. Thus, one set of locking bolts (not shown) engages the pipeline assembly to establish electrical continuity, but not both sets.

Another aspect of the present invention is a method of improving the sealing characteristics of a pipeline. Occasionally, a pipe is porous, has a buildup of graphite, or a rough, pitted or generally poor surface to the point that the surface is not conducive to affecting a tight seal. That may be a problem when attaching a split sleeve or other products relying upon a compression seal to perform their intended function. In these cases, the pipe may be aggressively cleaned by sand or grit blasting, wire brushing or some other method to the point that it is an appropriate surface to accept a bonded product. The bonded product may be, for example, an epoxy (for steel pipes), fiberglass, polyurethane or other polymers, or a cementitious product (for cement pipes). Preferably, these bonded products are quick setting. Alternatively, the bonded product may be applied and allowed to cure. After setting of the bonded product, the compression sealing product, for example a split sleeve, can be installed and a tight fluid seal can be achieved. This process may also provide valuable other benefits such as acting as a dielectric or insulator; adding reinforcing material to the bonded product that strength a weakened pipe; smoothing the pipe to facilitate ease of movement (axially and radially) of a split sleeve. Additionally, the bonded products may be used to adjust the size of the pipe or to even out any non-uniformities in the size of the pipe.

While the specific embodiments have been illustrated and described, numerous modifications come to mind without significantly departing from the spirit of the invention and the scope of protection is only limited by the scope of the accompanying claims.

1. A method for connecting a branch on a pipeline assembly having a radial circumference and an axial length without stoppage of passage of flow of a fluid through the pipeline assembly comprising the steps of:
mounting a sleeve around a portion of the radial circumference of the pipeline assembly, the sleeve comprising a first sleeve portion and a second sleeve portion, wherein the first sleeve portion comprises a cutting tool and the second sleeve portion comprises a branch for connection onto the pipeline assembly;
securing the sleeve to the pipeline assembly;
milling a portion of the pipeline assembly to create an aperture at a desired location in the pipeline assembly, wherein the aperture is milled to a length and width at the desired location by use of the cutting tool;
rotating the sleeve radially so that the second sleeve portion is aligned with the aperture in the pipeline assembly; and
connecting the branch onto the pipeline assembly while the second sleeve portion is aligned with the aperture.

2. The method of claim 1 comprising the additional step of sliding the sleeve radially and then milling by use of the cutting tool an additional length of the pipeline assembly before aligning the aperture with the branch.

3. The method of claim 1 comprising the additional step of sliding the sleeve axially and then milling by use of the cutting tool an additional width of the pipeline assembly before aligning the aperture with the branch.

4. The method of claim 1 wherein the second sleeve portion comprises a valve.

5. The method of claim 4 comprising the additional step of opening the valve after the connecting step.

6. The method of claim 1 wherein the connecting step comprises connecting a side top branch.

7. The method of claim 1 wherein the connecting step comprises connecting a bottom side branch.

8. The method of claim 1 wherein the pipeline assembly is made of steel.

9. The method of claim 1 wherein the pipeline assembly is made of iron.

10. The method of claim 1 wherein the pipeline assembly is made of polyvinyl chloride.

11. The method of claim 1 wherein the pipeline assembly is made of fiberglass.

12. The method of claim 1 wherein the pipeline assembly is made of polyethylene.

13. The method of claim 1 wherein the area of the aperture is approximately the same as the cross sectional area of the pipeline assembly.

14. The method of claim 1 wherein the first sleeve portion and second sleeve portion are separated by 90° in the radial direction.

15. The method of claim 1 wherein the first sleeve portion and second sleeve portion are separated by 60° in the radial direction.

16. The method of claim 1 wherein the sleeve is a split sleeve.

17. The method of claim 1 wherein the cutting tool is a milling machine.

18. The method of claim 1 comprising the additional step of rotating the sleeve radially and milling a second aperture at a second desired location by use of a cutting tool, wherein the sleeve comprises a third sleeve portion, the third sleeve portion comprising a second branch that is connected to the pipeline assembly and aligned with the second aperture.

19. An apparatus for connecting a branch onto a pipeline assembly without stoppage of passage of flow of fluid through the pipeline assembly having a circumference, the apparatus comprising:
a sleeve comprising a first sleeve portion and a second sleeve portion, wherein the first sleeve portion comprising an area capable of receiving a milling machine and a valve, and the second sleeve portion comprises a branch to be connected onto the pipeline, wherein the sleeve is rotatable about the circumference of the pipeline assembly to permit milling of the pipeline assembly of variable lengths.

20. A method of removing milling residue from a sleeve and pipeline assembly, without stopping fluid flow in the pipeline assembly, comprising the steps of:
isolating the area around a milling machine and pipeline assembly;
providing a chamber to receive residue from the milling machine;
milling material from the pipeline assembly to form a residue; and
using a magnet to attract the residue into the chamber.

21. The method of claim 19 wherein the magnet is inserted by a rod.

22. The method of claim 19 wherein the magnet is within the chamber.

23. The method of claim 19 wherein the magnet is within the pipeline assembly during the using a magnet step.

24. The method of claim 19 wherein the magnet is a brush with magnetized bristles.

25. The method of claim 24 wherein the brush has an open position and a closed position, the brush being in the closed position during insertion into the pipeline assembly.

26. A method of electrically isolating a section of a pipeline assembly, without stopping fluid flow in the pipeline assembly with a radial circumference and an axial length, comprising the steps of:
mounting a sleeve around a portion of the radial circumference of the pipeline assembly, the sleeve comprising a milling machine and a portion adapted to attach to the section of the pipeline assembly;
securing the sleeve to the pipeline assembly;
milling the pipeline assembly through 360 degrees in the radial direction at a desired axial location by use of the milling machine to form the electrically isolated section; and
attaching the sleeve to the electrically isolated section of the pipeline assembly.

27. A cutting tool for milling a slot in a pipeline assembly comprising:
a substantially cylindrical body having a top end surface, bottom end surface and outer circumferential surface;
a plurality of first tips projecting out from the bottom end surface of the body and away from the body;
a plurality of second tips projecting out from the top end surface of the body and away from the body;
a plurality of third tips projecting out from the circumferential surface, wherein the first tips are configured to be used for penetration of the tool into the pipeline assembly, the second tips are configured to be used for milling through the pipeline assembly and the third tips are configured to be used for retraction of the cutting tool from the pipeline.

28. A method for improving the sealing characteristics of a portion of a pipeline assembly comprising:
providing a portion of the pipeline assembly;
cleaning the portion of the pipeline assembly; and
applying a bonding product to the pipeline assembly that improves the sealing characteristics of the portion of the pipeline assembly.

29. The method of claim 28 wherein the bonding product is an epoxy.

30. The method of claim 28 wherein the bonding product is fiberglass.

31. The method of claim 28 wherein the bonding product is cementitious.
